(19) United States
(12) Patent Application Publication
(10) Pub. No.: US 2011/0192179 A1
(43) Pub. Date: Aug. 11, 2011

(54) EVAPORATIVE HEAT TRANSFER SYSTEM AND METHOD

(76) Inventors: William F. Freije, III, Indianapolis, IN (US); Peter L. Freije, Atlanta, GA (US)

(21) Appl. No.: 12/701,124

(22) Filed: Feb. 5, 2010

(51) Int. Cl. F28C 3/08; F25D 31/00; G05D 7/00

(52) U.S. Cl. 62/121; 62/303; 62/259.4; 700/282

(57) ABSTRACT

An evaporative heat transfer system is disclosed wherein a portion of a heat transfer fluid is evaporated and a remainder of the heat transfer fluid is collected in a sump. A characteristic of the heat transfer fluid is monitored. A first fluid input system and a second fluid input system are provided. The first fluid input system provides a first heat transfer fluid to the evaporative heat transfer system. The second fluid input system provides a second heat transfer fluid to the evaporative heat transfer system.

### FIELD

The present invention relates to heat transfer systems. More specifically, the invention relates to systems and methods for managing a heat transfer fluid of an evaporative heat transfer system.

### BACKGROUND

Exemplary evaporative heat transfer systems include cooling tower systems, evaporative condenser systems, and fluid cooler systems. In these evaporative heat transfer systems a first fluid is pumped to an application heat exchanger device. The first fluid takes on heat from the application heat exchanger device thereby cooling a second fluid of the application heat exchanger device. Exemplary application heat exchanger devices may be a part of an air condition system, a refrigeration system, a manufacturing system, an electrical power generation system, and other suitable systems wherein a fluid needs to be cooled. The additional heat transferred to the first fluid of the evaporative heat transfer system from the application heat exchanger device is removed at least through the evaporation of a portion of the first fluid. The remainder of the first fluid of the evaporative heat transfer system is collected in a sump for circulation by a pump back to the application heat exchanger device.

In the case of a cooling tower system, the application heat exchanger device is positioned outside of the cooling tower. The first fluid is pumped from the sump associated with the cooling tower to the application heat exchanger device whereat the first fluid is heated through an interaction with the application heat exchanger device. In the process, a second fluid of the application heat exchanger is cooled. The heated first fluid is returned to the cooling tower where it is sprayed over a fill material within the cooling tower. As the first fluid falls through the cooling tower a portion of first fluid evaporates; thereby cooling the remainder of the first fluid. The remainder of the first fluid is collected in a sump and recirculated back to the application heat exchanger device to take on additional heat.

In the case of an evaporative condenser system, the application heat exchanger device is positioned within a housing of the evaporative condenser system. The first fluid is pumped from the sump associated with the evaporative condenser system to a top portion of the housing of the evaporative condenser system. The first fluid is sprayed over the fluid conduits of the application heat exchanger device, which is the condenser unit of the evaporative condenser system. The condenser unit includes fluid conduits which are carrying a second fluid that has been heated. Heat from the hotter second fluid is transferred to the sprayed first fluid within the condenser unit. This results in a portion of the sprayed first fluid evaporating. The second fluid exits the condenser unit cooler than when it entered and the remainder of the first fluid is collected in a sump of the evaporative condenser system. In general, the second fluid enters the condenser unit as a gas and exits the condenser unit as a liquid.

A fluid cooler system operates in the same manner as an evaporative condenser system. A fluid cooler differs in that a hot liquid is the second fluid that enters the condenser unit. It leaves as a cooled liquid.

The remainder of the first fluid collected in the sump, in the cooling tower example, the evaporative condenser example, and the fluid cooler example, has a higher concentration of contaminants which were not evaporated with the first fluid. Exemplary contaminants include minerals, dirt, organic material, biological material, and other dissolved and suspended solids. Over time, the circulating first fluid becomes more and more concentrated as more and more of the first fluid evaporates since the minerals and solids are left behind. Leaving these contaminants in the circulating water in high concentration can lead to scale buildup, corrosion, sediment and microbiological problems.

In order to control the level of concentration of these minerals and solids in the sump basin, the above-mentioned systems periodically bleed the first fluid out of the respective system and replace it with less concentrated makeup water in order to dilute the first fluid and reduce the concentration. A controller measures the total mineral content or conductivity of the first fluid (which rises with mineral content) and opens a solenoid valve connected to a bleed line when the conductivity of the first fluid rises to a preset value. This process keeps the circulating first fluid within the desired level of concentration. A measurement of the concentration of the first fluid relative to fresh make-up water is commonly referenced in terms of cycles of concentration. Two cycles of concentration refers to the contaminant concentration of the first fluid being double that of the contaminant concentration of the fresh heat transfer fluid. Three cycles of concentration refers to the contaminant concentration of the first fluid being triple that of the contaminant concentration of the fresh heat transfer fluid, and so on. By operating at higher cycles of concentration the systems bleed less of the first fluid, generally water, which reduces the overall fluid usage in the system. Some systems include chemicals in the first fluid to enhance the ability of the first fluid to function effectively at higher levels of concentration.

### SUMMARY

In one exemplary embodiment of the present disclosure, multiple fluid input systems are provided to furnish respective heat transfer fluids to at least one injection point of an evaporative heat transfer system. In another exemplary embodiment of the present disclosure, a method of controlling the provision of heat transfer fluid from multiple fluid input systems to at least one injection point of an evaporative heat transfer system.

In a further exemplary embodiment of the present disclosure, a method of regulating a heat transfer fluid of an evaporative heat transfer system having a sump which contains the heat transfer fluid is provided. The method comprising the steps of: providing a first fluid input system in fluid communication with a first injection point of the evaporative heat transfer system, the first fluid input system providing a first heat transfer fluid to the evaporative heat transfer system, the first heat transfer fluid having a first conductivity; providing a second fluid input system in fluid communication with a second injection point of the evaporative heat transfer system, the second fluid input system providing a second heat transfer fluid to the evaporative heat transfer system, the second heat transfer fluid having a second conductivity, the second conductivity being lower than the first conductivity; controlling the first fluid input system to add the first heat transfer fluid to the evaporative heat transfer system at the first injection point based on a height of the heat transfer fluid in the sump; and controlling the second fluid input system to add the second heat transfer fluid to the evaporative heat transfer system at the second injection point based on a conductivity of the heat transfer fluid.

In still another exemplary embodiment of the present disclosure, a method of regulating a heat transfer fluid of an evaporative heat transfer system having a sump which contains the heat transfer fluid is provided. The method comprising the steps of: providing a first fluid input system, the first fluid input system being in fluid communication with a first injection point of the evaporative heat transfer system, the first fluid input system providing a first heat transfer fluid to the evaporative heat transfer system, the first heat transfer fluid having a first conductivity; providing a second fluid input system, the second fluid input system being independent of the first fluid input system and not in fluid communication with the first fluid input system, the second fluid input system being in fluid communication with a second injection point of the evaporative heat transfer system, the second fluid input system providing a second heat transfer fluid to the evaporative heat transfer system, the second heat transfer fluid having a second conductivity, the second conductivity being lower than the first conductivity; circulating the heat transfer fluid to a first heat transfer system which adds heat to the heat transfer fluid and onto a second heat transfer system which removes heat from the heat transfer fluid through an evaporation of a portion of the heat transfer fluid; monitoring a characteristic of the heat transfer fluid; adding the first heat transfer fluid to the heat transfer fluid if a first value of the characteristic of the heat transfer fluid is reached; and adding the second heat transfer fluid to the heat transfer fluid when a second value of the characteristic of the heat transfer fluid is reached, the first value of the characteristic of the heat transfer fluid and the second value of the characteristic of the heat transfer fluid being selected such that the heat transfer fluid reaches the second value of the characteristic of the heat transfer fluid prior to the first value of the characteristic of the heat transfer fluid. In one example, the characteristic is a height of the heat transfer fluid in the sump of the evaporative heat transfer system, the first value corresponding to a first height and the second value corresponding to a second height, the first height being lower than the second height. In another example, the characteristic is a conductivity of the heat transfer fluid of the evaporative heat transfer system, the first value corresponding to a first conductivity value of the heat transfer fluid and the second value corresponding to a second conductivity value of the heat transfer fluid, the first conductivity value being higher than the second conductivity value.

In yet another exemplary embodiment of the present disclosure, an apparatus for regulating a heat transfer fluid of an evaporative heat transfer system having a sump containing the heat transfer fluid and a fluid circuit which circulates the heat transfer fluid to a first heat transfer system which adds heat to the heat transfer fluid is provided. The evaporative heat transfer system removes heat from the heat transfer fluid through an evaporation of a portion of the heat transfer fluid. The evaporative heat transfer system includes a first valve which adds a first heat transfer fluid to the heat transfer fluid when a fluid level of the heat transfer fluid in the sump falls below a first height setpoint. The apparatus comprising a fluid treatment device which receives fluid from a fluid supply, the fluid being independent of the evaporative heat transfer fluid, the fluid treatment device treating the received fluid to produce a second heat transfer fluid having a second conductivity lower than a first conductivity of the first heat transfer fluid; a second valve having a first configuration wherein the second heat transfer fluid is not added to the heat transfer fluid and a second configuration wherein the second heat transfer fluid is added to the heat transfer fluid of the heat transfer system; a sensor which monitors a conductivity of the heat transfer fluid; and a controller which is operatively coupled to the second valve. The controller configures the second valve in the second configuration when the conductivity of the heat transfer fluid rises to a first setpoint level. The second conductivity of the second heat transfer fluid being lower than the first setpoint level. The controller configures the second valve in the first configuration when the conductivity of the heat transfer fluid falls to a second setpoint level. The second conductivity of the second heat transfer fluid being lower than the second setpoint level.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 illustrates an evaporative condenser system having a first fluid input system and a second fluid input system;

FIG. 2 illustrates an exemplary membrane system which provides fluid to an injection point of the evaporative condenser system of FIG. 1;

FIG. 2A illustrates an exemplary membrane system coupled to a holding tank which provides fluid to an injection point of the evaporative condenser system of FIG. 1;

FIG. 2B illustrates an exemplary membrane system coupled to a holding tank which provides fluid to an injection point of the evaporative condenser system of FIG. 1;

FIG. 2C illustrates an exemplary membrane system coupled to a holding tank which recirculates fluid back to the membrane system;

FIG. 3 illustrates the evaporative condenser system of FIG. 1 wherein the second fluid input system is a membrane system;

FIG. 4 illustrates the evaporative condenser system of FIG. 1 wherein the second fluid input system is a membrane system and a sump of the evaporative condenser system is remote from a condenser system;

FIG. 5 illustrates an exemplary cooling tower system having a first fluid input system and a second fluid input system, the second fluid input system being a membrane system;

FIG. 6 illustrates the cooling tower system of FIG. 5 wherein the second fluid input system is a membrane system and a sump of the cooling tower system is remote from a cooling tower unit;

FIG. 7 illustrates the exemplary conductivity percentage of the fluid of the evaporative condenser system of FIG. 1 over time relative to the conductivity of fresh make-up water not treated by the membrane system; and

FIG. 8 illustrates an exemplary fluid treatment device for use with the evaporative condenser system of FIG. 1.

Corresponding reference characters indicate corresponding parts throughout the several views. The exemplifications set out herein illustrate embodiments of the disclosure and such exemplifications are not to be construed as limiting the scope of the invention in any manner.

### DETAILED DESCRIPTION OF THE DRAWINGS

The embodiments of the invention described herein are not intended to be exhaustive or to limit the invention to the precise forms disclosed. Rather, the embodiments elected for description have been chosen to enable one skilled in the art to practice the invention.

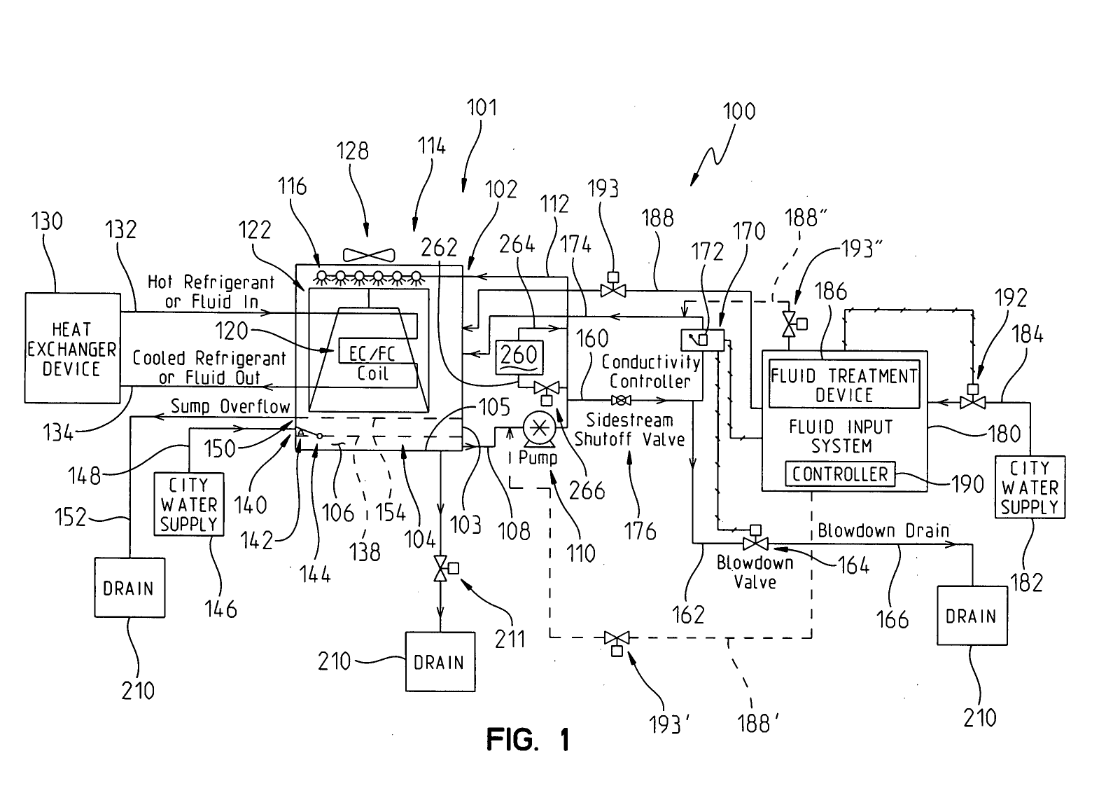

Referring to FIG. 1, an evaporative condenser system 100 is shown. Evaporative condenser system 100 is an exemplary evaporative heat transfer system. Other exemplary evaporative heat transfer systems include fluid cooler systems and cooling tower systems. Evaporative condenser system 100 includes an evaporation unit 101 having a housing 102 and an associated sump basin 104. Evaporation unit 101 cools a heat transfer fluid by evaporating a portion of the heat transfer fluid. A condenser unit 122 is provided within the housing 102. Housing 102 may be an open air support structure which allows air to travel into and out of housing 102.

A heat transfer fluid 106 is contained within sump basin 104 of evaporation unit 101. Exemplary heat transfer fluids include any type of liquid. In one embodiment, fluid 106 is simply water. In one embodiment, fluid 106 is a water based fluid including one or more chemicals. Exemplary chemicals include sulfuric acid, phosphonates, biocides, and other exemplary chemicals.

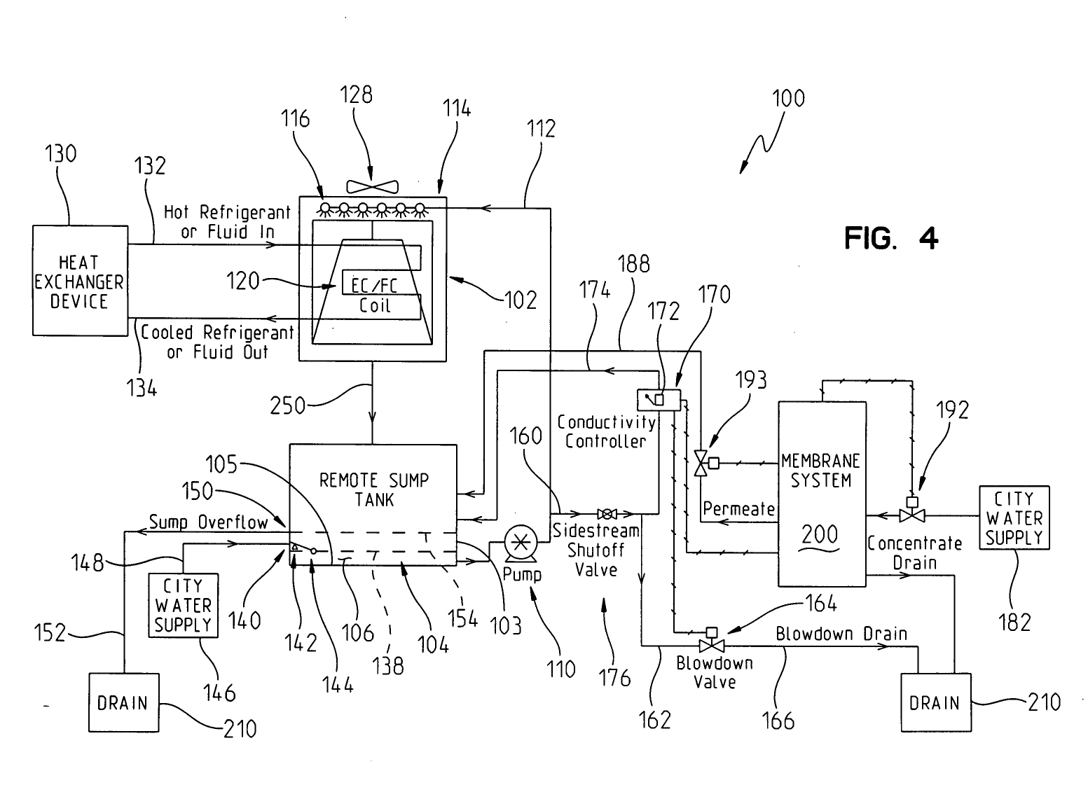

Sump basin 104 includes a floor 105 and a plurality of sides 103. Sump basin 104 is shown as being part of housing 102. Referring to FIG. 4, sump basin 104 is shown as being remote from housing 102 of evaporation unit 101.

Fluid 106 is passed from sump basin 104 into a fluid conduit 108. Fluid conduit 108 is in fluid communication with a suction side of a circulating pump 110. Pump 110 pumps the fluid 106 through a fluid conduit 112 up to a top portion 114 of housing 102 of evaporative unit 101. The fluid 106 is sprayed out through spray members 116 supported at top portion 114 of housing 102. The fluid 106 is sprayed over a heat transfer member 120 of condenser unit 122. The condenser unit 122 is an application heat exchanger device in that the heat transfer member 120 carries a second heat transfer fluid which is to be cooled.

In one embodiment, evaporative condenser system 100 does not include fluid conduit 108. In one example, circulating pump 110 is coupled to side 103 of sump basin 104. In one example, circulating pump 110 is a submersible pump positioned within sump basin 104 and fluid conduit 112 passes through side 103 of sump basin 104.

An exemplary heat transfer member 120 is a coil containing the heat transfer fluid. The heat transfer fluid takes on heat in one or more remote heat exchanger devices 130 and flows to condenser system 122 through a fluid conduit 132. The heat transfer fluid passes through the coil of the heat transfer member 120. The fluid 106 sprayed down on heat transfer member 120 takes on heat transferred from the heat transfer fluid passing through the heat transfer member 120. This results in the heat transfer fluid being cooled as it exits condenser system 122 through fluid conduit 134 and results in a portion of fluid 106 evaporating. The cooled heat transfer fluid travels through fluid conduit 134 back to the one or more remote heat exchanger devices 130 to take on additional heat. Exemplary heat exchanger devices 130 include air conditioning systems and refrigeration systems.

In the above embodiment of evaporative condenser system 100, the second heat transfer fluid enters condenser unit 122 as a hot gas and exits condenser unit 122 as a liquid. Of course, condenser unit 122 may be part of a fluid cooler instead of an evaporative condenser system 100. In a fluid cooler, the second heat transfer fluid enters condenser unit 122 as a hot liquid and exits condenser unit 122 as a cooled liquid. Exemplary heat transfer fluids include oil, water, glycol, and other suitable heat transfer fluids. Since the teachings disclosed herein are applicable to both evaporative condensers and fluid coolers, condenser unit 122 is shown with the textual label EC/FC to indicate that it may be a part of either type of system. Further, fluid conduit 132 is shown with the textual label of Hot Refrigerant or Fluid In and fluid conduit 134 is shown with the textual label of Cooled Refrigerant or Fluid Out.

Returning to FIG. 1, a fan 128 causes a high volume of air to be drawn up through the heat transfer member 120. Of course the fan 128 may be positioned to force air towards heat transfer member as well. The air mixes with fluid 106. During this process, evaporation of fluid 106 occurs and the contaminants, such as minerals and other dissolved and suspended solids, which were in the fluid 106 are left behind and fall into sump basin 104 with the remainder of fluid 106 sprayed over heat transfer member 120. This increases the mineral content of fluid 106 in sump basin 104 which also raises the conductivity of the fluid 106 in sump basin 104. Leaving these contaminants in the fluid 106 in the sump basin 104 in high concentration may lead to scale buildup, corrosion, sediment and microbiological problems for condenser system 122 and other components of evaporative condenser system 100. This reduces the efficiency of the heat transfer from the heat transfer fluid passing through heat transfer member 120 to the fluid 106.

In addition to the rising contaminant concentration, over time the evaporation of fluid 106 causes a top level 138 of fluid 106 in sump basin 104 to fall. A fluid input system 140 monitors top level 138 of fluid 106 and adds additional fluid 106 to sump basin 104 as needed. In the illustrated embodiment, fluid input system 140 includes a valve 142 which is coupled to a mechanical float 144. Mechanical float 144 generally tracks top level 138. As top level 138 falls, mechanical float 144 is moved. This movement of mechanical float 144 results in valve 142 being opened. Mechanical float 144 is one example of a height measuring sensor for monitoring top level 138 of fluid 106. Other exemplary height measuring sensors include capacitive sensors, ultrasonic sensors, optical sensors, conductive probes, and other suitable height measuring sensors. When valve 142 is opened, fluid from a first fluid supply 146 is provided through a fluid conduit 148 into sump basin 104. When valve 142 is closed, fluid from first fluid supply 146 is not provided through fluid conduit 148 into sump basin 104. As illustrated, fluid input system 140 adds fluid from first fluid supply 146 to the fluid 106 in sump basin 104. In an alternative embodiment, fluid input system 140 adds fluid from first fluid supply 146 through one of the fluid conduits 108 and 112.

In one embodiment, first fluid supply 146 includes one or more fluid treatment devices which treat the water. Exemplary fluid treatment devices include chemical additive stations, water softeners, and other suitable fluid treatment devices. Additional exemplary fluid treatment devices include electrical fluid treatment devices which alter the properties of the fluid through the application of an alternating electrical current to the fluid, either through direct contact with the fluid or by indirect contact with the fluid. One example of indirect contact with the fluid is wherein a fluid conduit carrying the heat transfer fluid has an electrical wire wrapped around an exterior thereof. Exemplary electrical fluid treatment devices include the EASYWATER brand water treatment system and the SERIES E brand water treatment system, both available from Freije Treatment Systems located at 4202 N. Awning Court in Greenfield, Ind. 46140. Exemplary electrical fluid treatment devices are disclosed in U.S. patent application Ser. No. 11/837,225; PCT Patent Application Number PCT/US08/09620; and PCT Patent Application Number PCT/US08/09621, the disclosures of which are expressly incorporated by reference herein.

While fluid input system 140 is provided to keep top level 138 of fluid 106 at a minimum level or above, a fluid outlet system 150 is provided to keep a top level of fluid 106 at or below a maximum level. In the illustrated embodiment, fluid outlet system 150 includes an overflow conduit 152 which is in fluid communication with sump basin 104. As top level 138 of fluid 106 rises, such as due to rainwater entering top portion 114 of housing 102, the fluid 106 exits sump basin 104 through overflow conduit 152 when top level 138 reaches a level 154. In one embodiment, the fluid 106 flows through overflow conduit 152 due to gravity. Absent fluid 106 rising to level 154, the fluid in sump basin 104 continues to become more concentrated with contaminants over time due to the continued evaporation of fluid 106.

In order to control the level of concentration of these minerals and solids in fluid 106 in sump basin 104, fluid 106 may be flushed down a drain 210 or moved to some other fluid disposal system. This is commonly referred to as a blow-down operation. As fluid 106 is removed from sump basin 104 a large amount of additional fluid is provided to sump basin 104 through fluid input system 140. This in essence flushes the more concentrated fluid 106 out of sump basin 104 replacing it with less concentrated make-up fluid.

In one embodiment, evaporative condenser system 100 includes a side stream fluid conduit 160 which is in fluid communication with fluid conduit 112 and which is in fluid communication with a fluid conduit 162. Fluid conduit 162 is in turn in fluid communication with a blow down valve 164. Valve 164 may be opened to communicate the fluid 106 to a fluid conduit 166 which carries the fluid 106 to the drain 210 or other fluid disposal system. Valve 164 is opened when a blow down operation is requested and closed when the blow down operation is complete. The state of valve 164 is controlled by a controller 170. In one embodiment, valve 164 is a solenoid valve.

Controller 170 is coupled to a conductivity sensor 172 which provides an indication of the conductivity of fluid 106 passing through a fluid conduit 174. Fluid conduit 174 is in fluid communication with side fluid conduit 160 through a manually actuated shutoff valve 176. Valve 176 is generally open during the operation of evaporative condenser system 100 so that fluid may flow past conductivity sensor 172. The fluid is returned to sump basin 104 through fluid conduit 174. Controller 170 monitors a conductivity level of fluid 106. In one embodiment, controller 170 opens valve 164 when the conductivity of fluid 106 rises to a first setpoint level (σ₁) and closes valve 164 when the conductivity of fluid 106 falls to a second setpoint level (σ₂). In one embodiment, first setpoint level (σ₁) and second setpoint level (σ₂) are set by the values of various circuitry components of controller 170, such as resistance values. In one example, the values for the various circuitry components of controller 170 may be adjusted to provide an operator with some adjustment of first setpoint level (σ₁) and second setpoint level (σ₂). In one embodiment, first setpoint level (σ₁) and second setpoint level (σ₂) are programmed values in software executed by a processor of controller 170.

Evaporative condenser system 100 further includes a second fluid input system 180. Second fluid input system 180 receives fluid, such as water, from a second fluid supply 182 through a fluid conduit 184. In the illustrated embodiment, both first fluid supply 146 and second fluid supply 182 are connections to a municipal water supply. Other exemplary fluid supplies may be used, such as holding tanks and other suitable fluid supplies. Second fluid input system 180 includes at least one fluid treatment device 186 which treats the fluid, illustratively water from fluid supply 182. Exemplary fluid treatment devices include chemical additive stations, water softeners, and other suitable fluid treatment devices. In one embodiment, the treated fluid provided by second fluid input system 180 has a lower conductivity than the fluid provided by fluid input system 140.

In one embodiment, second fluid input system 180 provides the treated fluid to sump basin 104 through a fluid conduit 188. In one embodiment, second fluid input system 180 provides the treated fluid through a fluid conduit 188′ which is in fluid communication with fluid conduit 108 on a suction side of pump 110. In one embodiment, fluid conduit 188′ is in fluid communication with fluid conduit 112 on a discharge side of pump 110. The fluid in fluid conduit 188′ being at a higher pressure than the fluid in fluid conduit 112 in this case. In one embodiment, second fluid input system 180 provides the treated fluid through a fluid conduit 188′ which is in fluid communication with fluid conduit 174. In general, second fluid input system 180 may be coupled to any portion of evaporative condenser system 100 which permits fluid from second fluid input system 180 to reach sump basin 104. The location that second fluid input system 180 is coupled to evaporative condenser system 100 is generally referred to as the injection point.

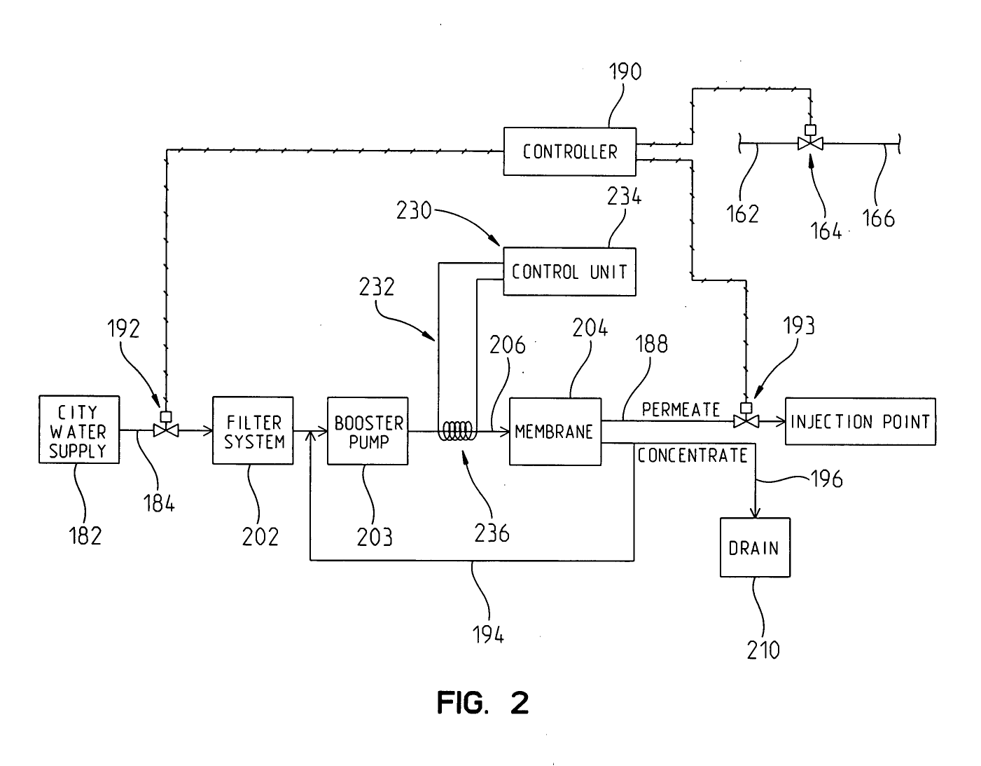

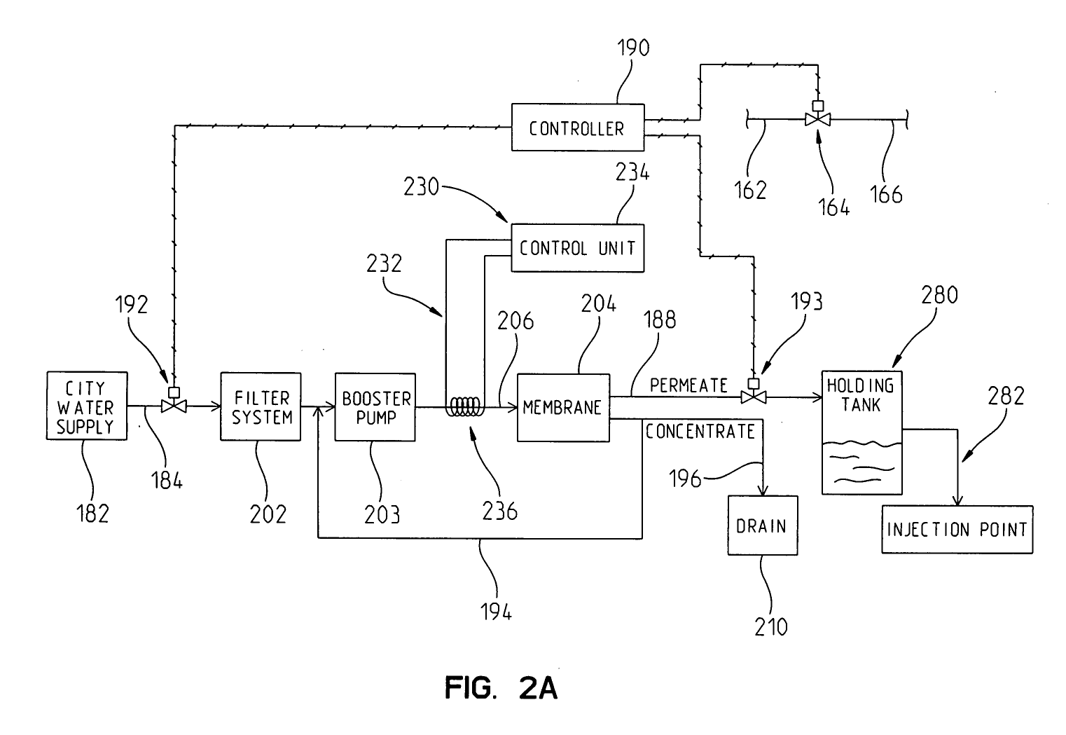

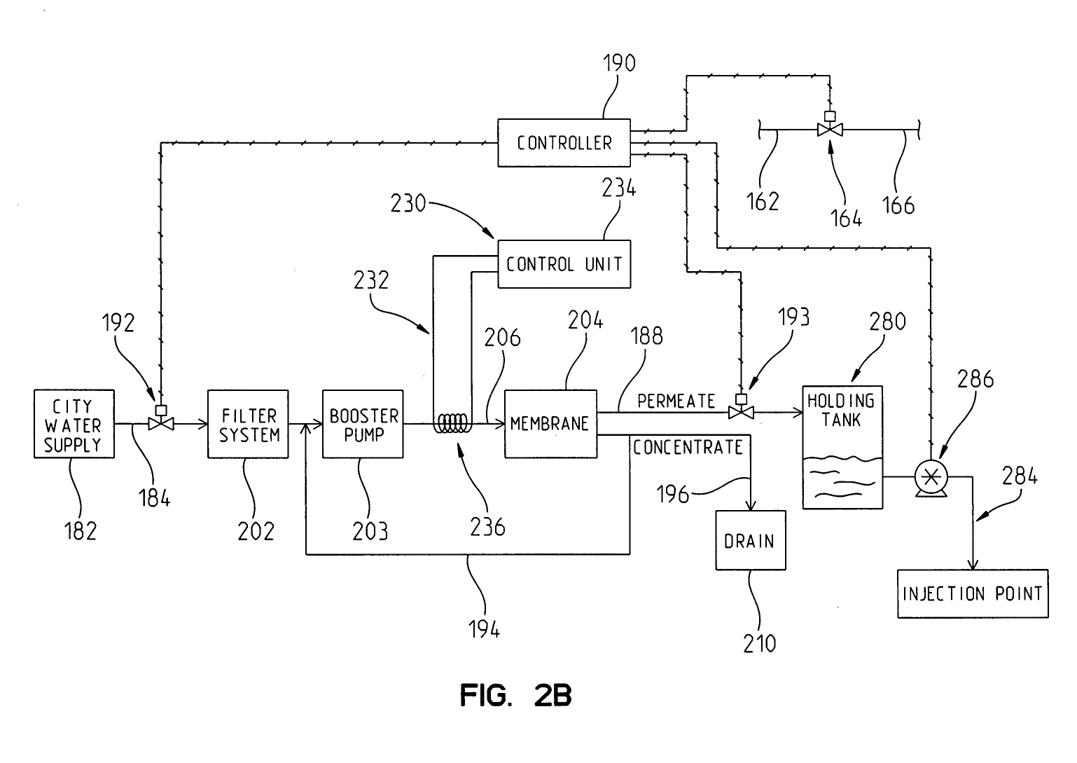

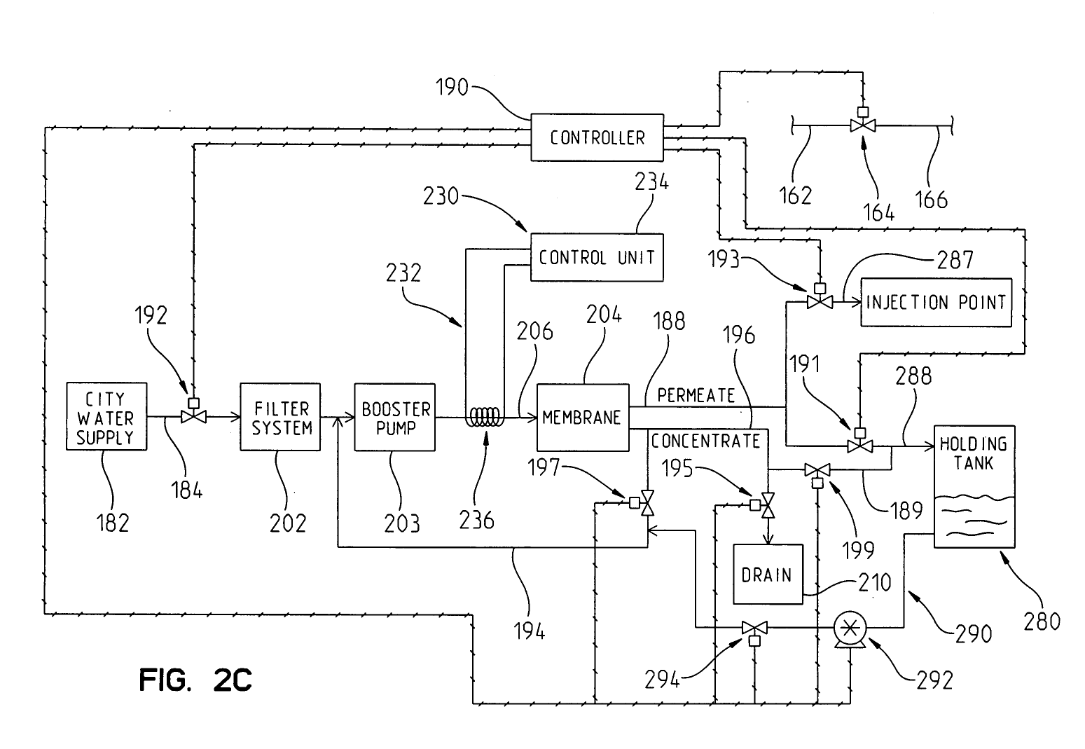

In one embodiment, fluid treatment device 186 is a membrane system 200 (see FIG. 2) which removes contaminants from the water received from second fluid supply 182. This results in the fluid passed onto the injection point having a lower conductivity than the fluid received from second fluid supply 182. Exemplary membrane systems 200 are disclosed in PCT Patent Application Serial No. PCT/US2008/009620, listing Freije Treatment Systems, Inc. as the applicant, the disclosure of which is expressly incorporated by reference herein.

Second fluid input system 180 does not continually provide fluid to the injection point of evaporative condenser system 100. Rather, a controller 190 of second fluid input system 180 controls the operation of a valve 192. Valve 192 is opened when fluid from second fluid input system 180 is to be delivered to the injection point and closed when fluid from second fluid input system 180 is to not be provided to the injection point. In one embodiment, valve 192 is a solenoid valve. In one embodiment, valve 192 is positioned on an entry side of second fluid input system 180. In one embodiment, valve 192 is provided on an exit side of second fluid input system 180. In the illustrated embodiment, valve 192 is positioned on the entry side of second fluid input system 180 and a second valve 193 is positioned on the exit side of second fluid input system 180. Second valve 193, in one embodiment, is also controlled by controller 190 to control the provision of fluid to the injection point.

In one embodiment, controller 190 determines when to open and close valve 192 based on a conductivity of fluid 106 in sump basin 104. In one embodiment, controller 190 is operatively coupled to conductivity sensor 172 so that controller 190 may monitor the conductivity of fluid 106 of sump basin 104. In one embodiment, controller 190 is operatively coupled to another sensor which monitors the conductivity of fluid 106 of sump basin 104. In one embodiment, controller 170 and controller 190 are combined into a single controller.

Controller 190 monitors a conductivity level of fluid 106. In one embodiment, controller 190 opens valve 192 (and valve 193 if present) when the conductivity of fluid 106 rises to a third setpoint level (σ₃) and closes valve 192 (and valve 193 if present) when the conductivity of fluid 106 falls to a fourth setpoint level (σ₄). In one embodiment, third setpoint level (σ₃) and fourth setpoint level (σ₄) are set by the values of various circuitry components, such as resistance values, of controller 190. In one example, the values for the various circuitry components may be adjusted to provide an operator with some adjustment of third setpoint level (σ₃) and fourth setpoint level (σ₄). In one embodiment, third setpoint level (σ₃) and fourth setpoint level (σ₄) are programmed values in software executed by a processor of controller 190.

In one embodiment, as the conductivity level of fluid 106 increases evaporative condenser system 100 lowers the conductivity level by adding fluid treated by second fluid input system 180 to sump basin 104. This occurs when the conductivity of fluid 106 rises to the third setpoint level (σ₃). The conductivity of fluid 106 may be reduced in multiple ways. First, the fluid treated by second fluid input system 180 has a lower conductivity value than the third setpoint level (σ₃). As such, the addition of fluid treated by second fluid input system 180 reduces the conductivity of fluid 106 through the inclusion of the fluid treated by second fluid input system 180 in fluid 106. Second, as more and more fluid treated by second fluid input system 180 is added the top level 138 of fluid 106 in sump 104 continues to rise. In the absence of the conductivity of fluid 106 dropping to the fourth setpoint level (σ₄), fluid 106 rises to level 154 and begins to flow out of sump basin 104 through fluid outlet system 150. The fluid 106 lost through fluid outlet system 150 is replaced by additional fluid treated by second fluid input system 180. In one embodiment, the higher conductivity fluid 106 in sump basin 104 may also be evacuated in a controlled manner through valve 164 without needing to raise the top level 138 to level 154. The evacuation rate of fluid 106 should be selected to not cause a drop in top level 138 that would cause fluid input system 140 to start adding fluid as well. In one embodiment, a separate fluid conduit 209 and valve 211 are provided to move fluid from sump basin 104 to drain 210. Valve 211 may also be controlled by controller 170 or the controller 190 of second fluid input system 180.

In one embodiment, during normal operation second fluid input system 180 controls the conductivity of fluid 106 to be about 600% of the conductivity of the water from second fluid supply 182 (which is the same water as first fluid supply 146). In one embodiment, during normal operation second fluid input system 180 controls the conductivity of fluid 106 to be at least 600% of the conductivity of the water from second fluid supply 182. In one embodiment, during normal operation second fluid input system 180 controls the conductivity of fluid 106 to be about 1000% of the conductivity of the water from second fluid supply 182. In one embodiment, during normal operation second fluid input system 180 controls the conductivity of fluid 106 to be at least 1000% of the conductivity of the water from second fluid supply 182. In one embodiment, during normal operation second fluid input system 180 controls the conductivity of fluid 106 to be in the range of about 600% of the conductivity of the water from second fluid supply 182 to about 2000% of the conductivity of the water from second fluid supply 182. In one embodiment, during normal operation second fluid input system 180 controls the conductivity of fluid 106 to be in the range of about 600% of the conductivity of the water from second fluid supply 182 to about 1000% of the conductivity of the water from second fluid supply 182.

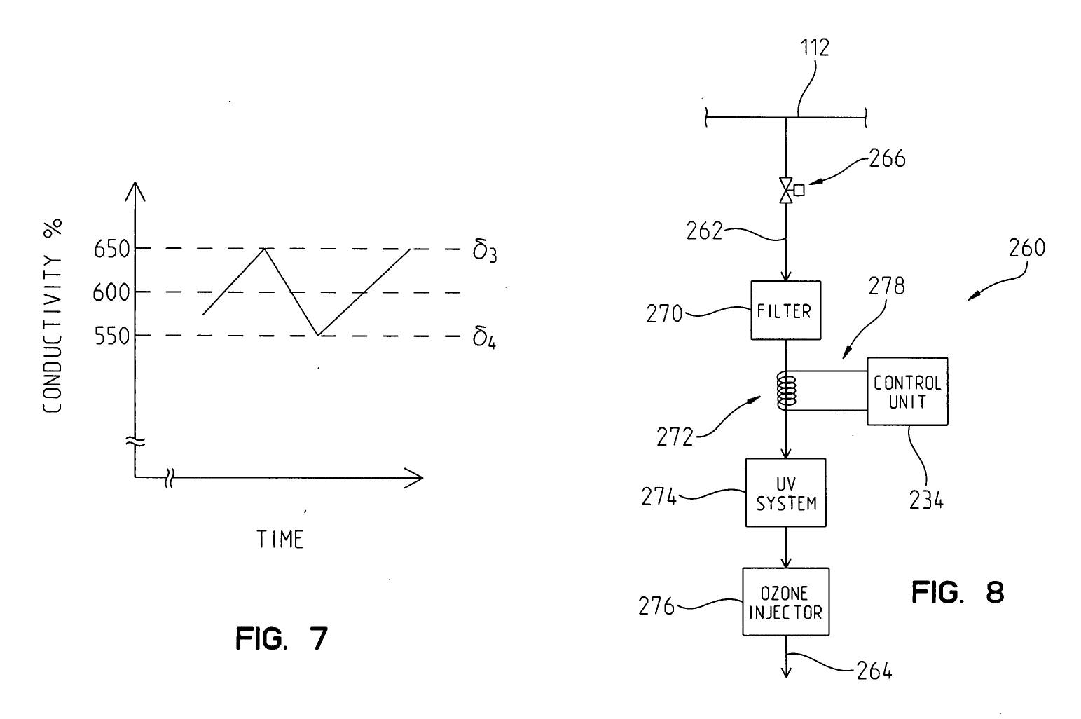

Referring to FIG. 7, in one embodiment, when the conductivity of fluid 106 is desired to be about 600% of the conductivity of the water from second fluid supply 182, fourth setpoint level (σ₄) is set to a first value lower than 600% and third setpoint level (σ₃) is set to a second value higher than 600%. As illustrated in FIG. 7, fourth setpoint level (σ₄) is illustratively set to 550% and third setpoint level (σ₃) is illustratively set to 650%. The conductivity of fluid 106 represented by the solid line bounces above and below 600%, but is generally confined to the band bounded by fourth setpoint level (σ₄) and third setpoint level (σ₃). Of course, the conductivity of fluid 106 may overshoot the band bounded by fourth setpoint level (σ₄) and third setpoint level (σ₃) based on the speed of correction of second fluid input system 180.

In one embodiment, during a clean-up operation wherein second fluid input system 180 is initially installed on a scaled existing system 100, second fluid input system 180 controls the conductivity of fluid 106 to be in the range of about 200% of the conductivity of the water from second fluid supply 182 (which is the same water as first fluid supply 146) to about 600% of the conductivity of the water from second fluid supply 182. In one embodiment, during a clean-up operation wherein second fluid input system 180 is initially installed on a scaled existing system 100, second fluid input system 180 controls the conductivity of fluid 106 to be in the range of about 250% of the conductivity of the water from second fluid supply 182 to about 400% of the conductivity of the water from second fluid supply 182.

In one embodiment, third setpoint level (σ₃) is selected to be lower than first setpoint level (σ₁). As such, as the conductivity of fluid 106 rises, second fluid input system 180 will begin to add fluid treated by second fluid input system 180 prior to the conductivity of fluid 106 reaching first setpoint level (σ₁). This prevents controller 170 from opening valve 164 to cause a blow down operation that will drop top level 138 of fluid 106 to a level that activates fluid input system 140. In this manner, valve 164 may be considered as a backup/emergency bleed system and fluid input system 140 as only being used for an initial fill of sump basin 104 and as a backup makeup source during normal operation of evaporative condenser system 100. If second fluid input system 180 were to cease operation or the permeate entering the sump basin 104 through fluid conduit 188 were to fall short of demand, fluid input system 140 would activate to add water to the sump basin 104 to keep the required level of water in sump basin 104

In one embodiment, sump basin 104 is initially filled or refilled with fluid input system 140. This fills the sump basin 104 to a level determined by the mechanical float 144. Several inches or feet above that normal operating water level is an overflow line 150. If the water level reaches the overflow line, the water is forced by gravity to a drain line. With second fluid input system 180, lower conductivity water treated by second fluid input system 180 is injected into the sump basin 104 or fluid conduit 108 and separate primary low conductivity (fourth setpoint level (σ₄)) and high conductivity (third setpoint level (σ₃)) setpoints are used to turn second fluid input system 180 off and on to control cycles of concentration of fluid 106. The second fluid input system 180 receives and interprets a 4-20 ma output from the controller 170 and by the programmed conductivity setpoints may control valve 192 (and valve 193 if present) to start and stop second fluid input system 180. In order to bleed or lower the concentration in the sump 104, second fluid input system 180 injects treated fluid directly into sump basin 104 or fluid conduit 108 and begins diluting fluid 106 and as a result begins raising the top level 138 of fluid 106 in sump basin 104 and lowering the overall conductivity of fluid 106 in sump basin 104. Once the top level 138 of fluid 106 in sump basin 104 approaches the overflow line 152, level 154, the fluid 106 begins to bleed by gravity out that line 152. This bleed will accelerate the reduction in the conductivity of the sump basin water as some of the higher conductivity fluid 106 in sump basin 104 is removed or bled out of evaporative condenser system 100 and replaced with the lower conductivity fluid from second fluid input system 180. This bleed from fluid outlet system 150 replaces the need for bleed from valve 164 and now serves as the primary source of bleed under normal operation of evaporative condenser system 100. The second fluid input system 180 continues injecting fluid into sump basin 104 and bleeding through the overflow line 152 until the user programmed primary low conductivity setpoint (fourth setpoint level (σ₄)) is reached. Once this point is reached, the second fluid input system 180 stops fluid production and the process of evaporation begins to reduce the overall top level 138 of fluid 106 in sump basin 104, thereby concentrating the fluid 106 and raising the conductivity. In order to prevent fluid input system 140 from initiating due to low water level and injecting the higher conductivity fluid into sump basin 104, the primary high conductivity (third setpoint level (σ₃)) and low conductivity (fourth setpoint level (σ₄)) setpoints are programmed so that second fluid input system 180 will under normal operation be initiated to inject fluid in sump basin 104 or fluid conduit 108 and repeat the diluting and bleeding through fluid outlet system 150 before the top level 138 of fluid 106 in sump basin 104 drops to the level where fluid input system 140 would be initiated.

In one embodiment, when second fluid input system 180 is triggered to provide fluid 106 to sump basin 104, an additional valve in fluid communication with sump basin 104 may be opened to bleed fluid from sump basin 104. In one embodiment, the additional valve is opened as the top level 138 of fluid 106 in sump basin 104 reaches a certain height monitored by a sensor, such as another mechanical float or any other suitable type of sensor for monitoring a height of fluid 106 in sump basin 104. The valve is left open until the fourth setpoint level (σ₄) is reached.

In one embodiment, a second mechanical float 144 is added to evaporative condenser system 100 at a height above the height of mechanical float 144. Whenever top level 138 of fluid 106 in sump basin 104 falls to the level associated with the second mechanical float 144, second fluid input system 180 is initiated to add fluid to the injection point, such as sump basin 104 or fluid conduit 108. As such, controller 190 monitors the second mechanical float or other height measuring sensor to determine when to activate second fluid input system 180 based on top level 138 of fluid 106.

In one embodiment, evaporative condenser system 100 includes a fluid treatment device 260 which receives fluid from fluid conduit 112 through a fluid conduit 262. Fluid treatment device 260 treats the fluid and returns it to fluid conduit 112 through a fluid conduit 264. The amount of fluid diverted to fluid treatment device 260 is controlled through a valve 264 which may be controlled by controller 170 or controller 190. It is understood that system 100 may in several places include check valves to control the direction of flow of the fluid. For instance, a check valve may be included in fluid conduit 264 to make sure fluid flows from fluid treatment device 260 to fluid conduit 112, not the reverse.

Referring to FIG. 8, fluid treatment device 260 may include one or more of a filter unit 270, an electrical treatment unit 272, a UV treatment system 274, and an ozone injector system 276. An exemplary filter unit 270 is a bag filter unit. Exemplary bag filter units are described in U.S. patent application Ser. No. 11/830,148, the disclosure of which is expressly incorporated by reference herein. An exemplary electrical treatment unit 272 is a wire 278 wrapped around fluid conduit 262. An electrical current controlled by control unit 234 passes through wire 278. Additional exemplary electrical treatment units may include electrodes in direct contact with the fluid. An exemplary UV treatment system 274 includes a UV source which exposes the fluid to UV radiation. An exemplary ozone injector system 276 injects ozone into the fluid.

Fluid treatment device 260 may also include a booster pump to force the fluid back into fluid conduit 112. In one embodiment, fluid conduit 262 and fluid conduit 264 are coupled to sump basin 104 instead of fluid conduit 112. As such, fluid treatment device 260 takes fluid directly out of sump basin 104 and returns it directly back into sump basin 104 once treated. In one embodiment, fluid conduit 262 is coupled to fluid conduit 112 and fluid conduit 264 is coupled to fluid conduit 108 on a suction side of circulating pump 110.

Referring to FIG. 2, an exemplary membrane system 200 is represented. Membrane system 200 includes a filter system 202 which receives the fluid from valve 192. In one embodiment, filter system 202 includes a pre-sediment filter unit and a carbon pre-filter unit which receives fluid from pre-sediment filter unit. The pre-sediment filter unit removes dirt and small particles that are in the fluid. The carbon pre-filter unit removes organic contaminants including chlorine. Fluid exiting filter system 202 is provided to a membrane unit 204 through a fluid conduit 206. In one embodiment, membrane unit 204 is one of a reverse osmosis membrane, a nano-filtration membrane, and an ultra-filtration membrane. In one embodiment, the fluid passes through a booster pump 203 which increases the pressure of the fluid prior to its entering membrane unit 204.

In membrane unit 204 the fluid is separated into a permeate stream which exits membrane unit 204 through fluid conduit 188 and flows to the injection point of evaporative condenser system 100 and a fluid waste stream which exits membrane unit 204 through a fluid conduit 196. The separation occurs through a membrane. In one embodiment, the membrane is a membrane cartridge. An exemplary membrane cartridge is Model No. W-1812-50 available from Watts Membranes located in Dunnellon, Fla. 34430.

The fluid conduit 196 passes the waste fluid to a drain 210 or other disposal. In one embodiment, a portion of fluid waste stream is recycled back to fluid conduit 206 through a fluid conduit 194. The percentage of the fluid waste that is communicated to drain 210 and recycled through fluid conduit 194 is controlled through flow control valves provided on fluid conduit 196 and fluid conduit 194, respectively. Further, a check valve may be provided along fluid conduit 194 to prevent the backflow of fluid in fluid conduit 194. In one embodiment, about 85 percent of the fluid waste stream is recycled back through fluid conduit 194 to pass through membrane unit 204 again. In one embodiment, at least about 85 percent of the fluid waste stream is recycled back through fluid conduit 194 to pass through membrane unit 204 again. In one embodiment, a portion of fluid waste stream of up to about 85 percent is recycled back through fluid conduit 194 to pass through membrane unit 204 again.

In one embodiment, a portion of fluid conduit 206 (or fluid conduit 184) is operatively coupled to an electrical treatment device 230. Electrical treatment device 230 includes a wire 232 which is wrapped around an exterior of fluid conduit 206 and a control unit 234. An exemplary electrical treatment device 230 is the EASYWATER brand water treatment system or SERIES E brand water treatment system both available from Freije Treatment Systems located at 4202 N. Awning Court, Greenfield, Ind. 46140. The EASYWATER brand water treatment system and SERIES E brand water treatment system both includes a wire wrapped around an exterior of the fluid conduit and a control unit. The control unit 234 passes a current through the wire which treats the fluid for mineral scale. In one embodiment, the electrical treatment device 230 applies an alternating current in the frequency range of about 1 kilo-hertz (kHz) to about 9 kHz. In one embodiment, the control unit 234 is incorporated as part of controller 190.

Electrical treatment device 230 treats the fluid passing through fluid conduit 206. Electrical treatment device 230 interfaces with fluid conduit 206 at a location 236 subsequent to fluid conduit 194 coupling to fluid conduit 206. In one embodiment, electrical treatment device 230 interfaces with fluid conduit 206 at a location 236 prior to fluid conduit 194 coupling to fluid conduit 206. In one embodiment, electrical treatment device 230 includes electrodes which are in direct contact with the water. In one embodiment, membrane system 200 includes a multi-stage membrane configuration wherein permeate from a first membrane unit is the input to a second membrane unit and so on. Additional electrical treatment devices may be used to treat the fluid between the stages of the multi-stage membrane configuration. Additional details regarding exemplary membrane systems 200 are disclosed in PCT Patent Application Serial No. PCT/US2008/009620, listing Freije Treatment Systems, Inc. as the applicant, the disclosure of which is expressly incorporated by reference herein.

Referring to FIG. 2A, in one embodiment, fluid conduit 188 is coupled to a holding tank 280. The permeate flowing through fluid conduit 188 is placed into holding tank 280. An overflow fluid conduit 282 passes fluid from holding tank 280 onto the injection point of evaporative condenser system 100. The fluid in holding tank 280 travels through overflow fluid conduit 282 due to gravity. In one embodiment, the injection point of evaporative condenser system 100 is sump basin 104.

Referring to FIG. 2B, in one embodiment, fluid conduit 188 is coupled to a holding tank 280. The permeate flowing through fluid conduit 188 is placed into holding tank 280. A fluid conduit 284 passes fluid from holding tank 280 onto the injection point of evaporative condenser system 100. The fluid in holding tank 280 travels through fluid conduit 284 due to the pumping action of a pump 286. In one embodiment, pump 286 is controlled by controller 190.

Referring to FIG. 2C, in one embodiment, fluid conduit 188 is coupled to both the injection point of evaporative condenser system 100 through a fluid conduit 287 and to a holding tank 280 through fluid conduit 288. Controller 190 controls valve 193 and valve 191 to control the proportion of the permeate passing onto the injection point of evaporative condenser system 100 and holding tank 280, respectively. The permeate flowing through fluid conduit 288 is placed into holding tank 280. Fluid may be removed from holding tank 280 through a fluid conduit 290. The fluid then is able to pass into fluid conduit 194 when valve 294 is opened. In one embodiment, a pump 292 is provided to pump the fluid into fluid conduit 194; however the pressure created by the fluid in the holding tank may be sufficient alone. The operation of pump 292 and valve 294, in one embodiment, is controlled by controller 190.

In one embodiment, the fluid in holding tank 280 is provided to fluid conduit 194 to clean out membrane 204. In operation, controller 190 closes a valve 197 on fluid conduit 194 to prevent the waste stream from membrane 204 to be recycled back. Controller 190 also closes valves 191 and 193 of the permeate stream. Valves 195 and 199 are also opened by controller 190 to connect the waste stream of fluid conduit 196 to holding tank 280 through fluid conduits 189 and 288. Valve 294 is opened by controller 190. Fluid from holding tank 280 passes into fluid conduit 194 and into the front end of membrane unit 204. This fluid removes buildup from membrane unit 204 and carries it out of the waste stream through fluid conduit 196; thereby cleaning membrane 204. The fluid passes back into the holding tank 280. Once membrane unit 204 has been cleaned, the fluid in holding tank 280 may be flushed to a drain or otherwise removed. The valves are then reset such that valves 191, 193, 195, and 197 are opened and valves 199 and 294 are closed.

The cleaning of membrane unit 204 with the fluid in holding tank 280 may also be implemented with the arrangements shown in FIGS. 2A and 2B.

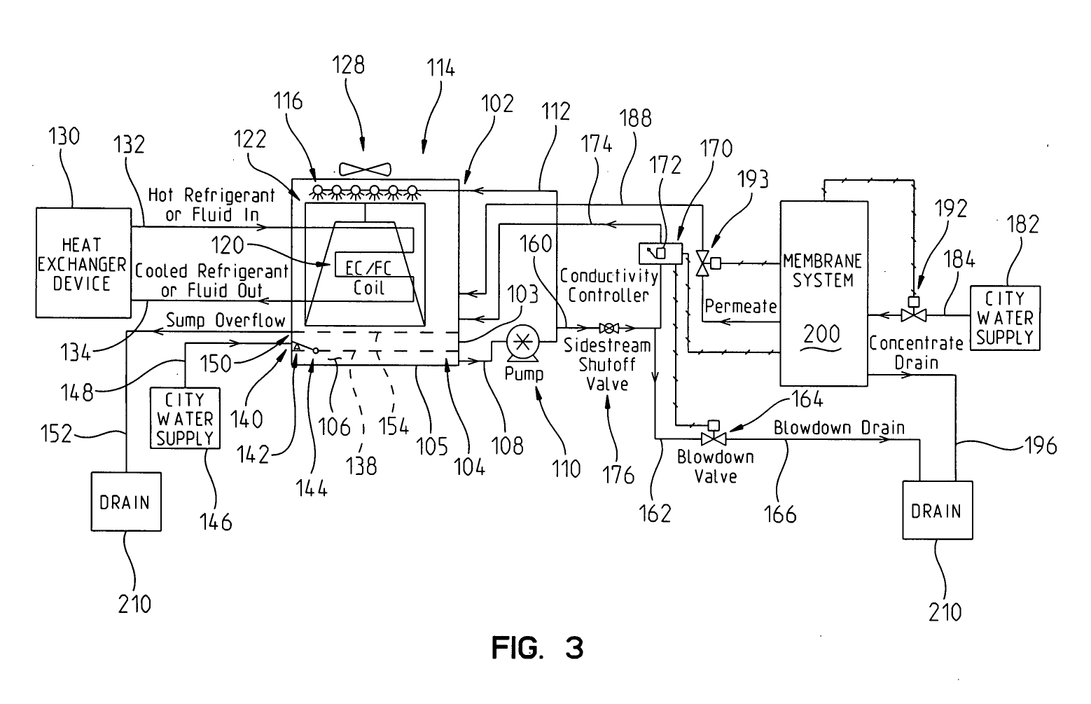

Referring to FIG. 3, evaporative condenser system 100 is shown including membrane system 200. Referring to FIG. 4, evaporative condenser system 100 is shown wherein sump basin 104 is remote from condenser unit 122. In the embodiment shown in FIG. 4, fluid 106 that passes through condenser unit 122 flows through a fluid conduit 250 to sump basin 104 which is spaced apart from condenser unit 122.

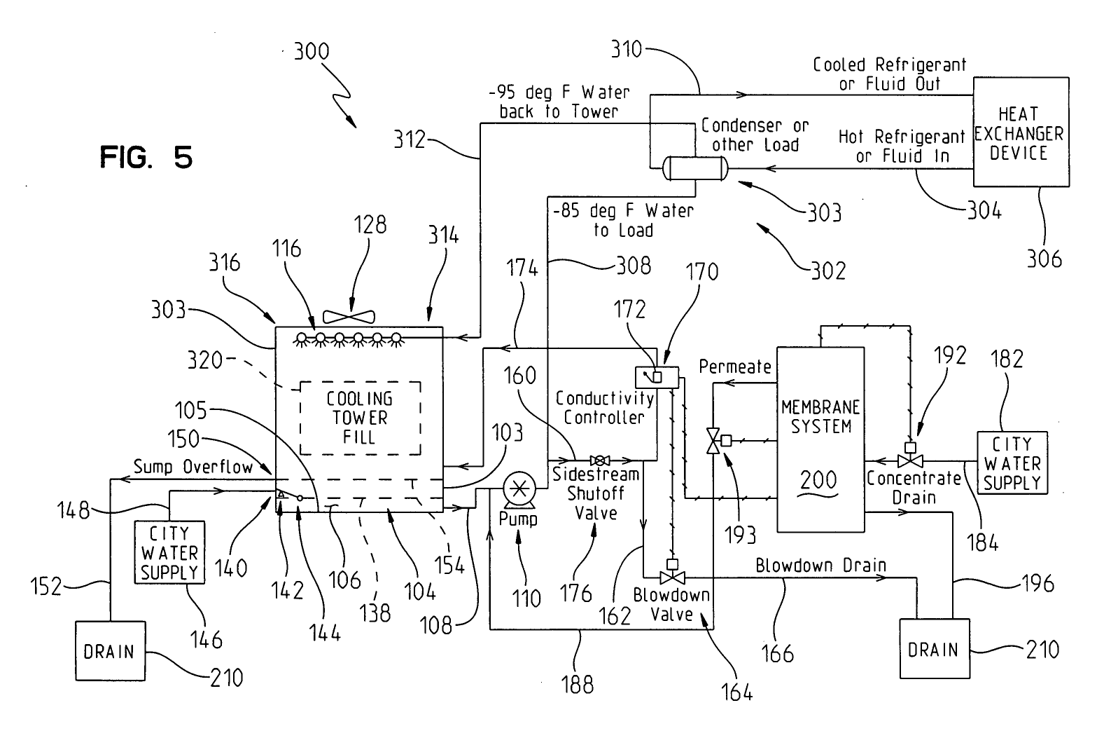

Referring to FIG. 5, an exemplary cooling tower system 300 is shown. Cooling tower system 300 operates in the same manner as evaporative condenser system 100 with regard to the treatment of the heat transfer fluid. As shown in FIG. 5 fluid from membrane system 200 is injected into fluid conduit 108 on the suction side of pump 110. Of course, fluid from membrane system 200 may be injected at any suitable injection point, such as directly into the sump basin 104.

In cooling tower system 300, fluid 106 from sump basin 104 is pumped by circulating pump 110 through a fluid conduit 308 to a remote heat transfer system 302. Exemplary heat transfer systems 302 include an application heat exchanger 303, such as a shell and tube condenser or a plate and frame heat exchanger. Application heat exchanger 303 receives a heated refrigerant or other heat transfer fluid through fluid conduit 304 from another heat exchanger device 306. Exemplary heat transfer devices 306 include refrigeration units and air conditioning units. Within application heat exchanger 303, heat from the heated refrigerant is transferred to fluid 106 and a cooled refrigerant exits application heat exchanger 303. The cooled refrigerant travels through a fluid conduit 310 back to heat exchanger device 306 to take on additional heat.

The now heated fluid 106 travels back to a top portion 314 of a housing 303 of a cooling tower 316 through a fluid conduit 312. The fluid 106 is sprayed by spray members 116 over a cooling tower fill material 320. Exemplary fill materials include PVC, wood slats, and masonry components. Fan 128 causes air to pass through cooling tower fill material 320 resulting in the evaporation of a portion of fluid 106. The remainder of fluid 106, just like in the case of evaporative condenser system 100, returns to sump basin 104 more concentrated.

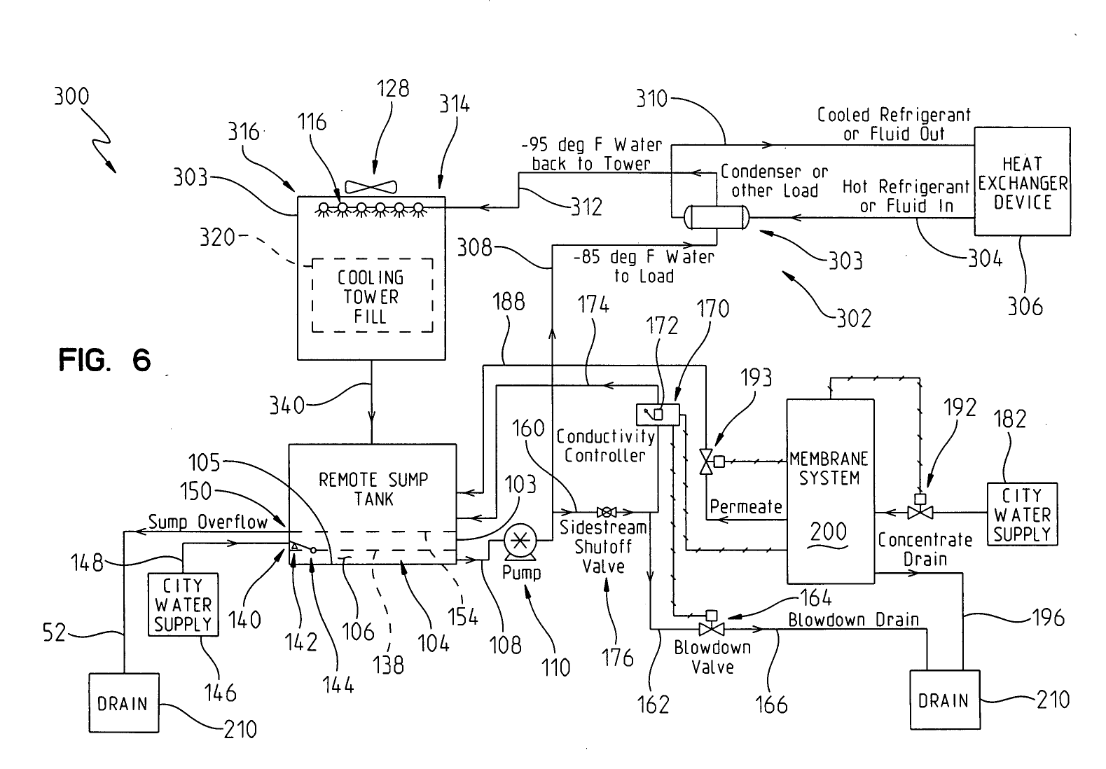

Referring to FIG. 6, cooling tower system 300 is shown wherein sump basin 104 is remote from cooling tower 316. In the embodiment shown in FIG. 6, fluid 106 that passes through cooling tower 316 flows through a fluid conduit 340 to sump basin 104 which is spaced apart from cooling tower 316.

In one embodiment, the evaporative heat transfer system is positioned on an exterior of a building, expect for a portion of fluid conduit 112 and potentially pump 110 and the fluid conduits associated with controller 170 and conductivity sensor 172. Those portions of evaporative heat transfer system are positioned on an inside of the building. In this embodiment, second fluid input system 180 is coupled to a portion of the evaporative heat transfer system positioned on the inside of the building.

Although the invention has been described in detail with reference to certain preferred embodiments, variations and modifications exist within the spirit and scope of the invention as described and defined in the following claims.

What is claimed is:

1. A method of regulating a heat transfer fluid of an evaporative heat transfer system having a sump which contains the heat transfer fluid; the method comprising the steps of:
providing a first fluid input system in fluid communication with a first injection point of the evaporative heat transfer system, the first fluid input system providing a first heat transfer fluid to the evaporative heat transfer system, the first heat transfer fluid having a first conductivity;
providing a second fluid input system in fluid communication with a second injection point of the evaporative heat transfer system, the second fluid input system providing a second heat transfer fluid to the evaporative heat transfer system, the second heat transfer fluid having a second conductivity, the second conductivity being lower than the first conductivity;
controlling the first fluid input system to add the first heat transfer fluid to the evaporative heat transfer system at the first injection point based on a height of the heat transfer fluid in the sump; and
controlling the second fluid input system to add the second heat transfer fluid to the evaporative heat transfer system at the second injection point based on a conductivity of the heat transfer fluid.

2. The method of claim 1, wherein the first injection point is the sump of the evaporative heat transfer system and the second injection point is one of the sump of the evaporative heat transfer system and a fluid conduit of the evaporative heat transfer system in fluid communication with the sump.

3. The method of claim 1, further comprising the step of evaporating a portion of the heat transfer fluid to remove heat from the heat transfer fluid.

4. The method claim 3, further comprising the step of circulating the heat transfer fluid to a first heat transfer system which adds heat to the heat transfer fluid and onto a second heat transfer system which removes heat from the heat transfer fluid through the step of evaporating the portion of the heat transfer fluid to remove heat from the heat transfer fluid.

5. The method of claim 3, wherein the evaporation of the portion of the heat transfer fluid results in the conductivity of the heat transfer fluid rising.

6. The method of claim 5, further comprising the steps of:
monitoring the conductivity of the heat transfer fluid; and
adding the second heat transfer fluid to the heat transfer fluid when the conductivity of the heat transfer fluid rises to a first setpoint level, the second conductivity of the second heat transfer fluid being lower than the first setpoint level.

7. The method of claim 6, further comprising the step of continuing to add the second heat transfer fluid to the heat transfer fluid until the conductivity of the heat transfer fluid falls to a second setpoint level.

8. The method of claim 7, wherein while the second fluid input system is adding the second heat transfer fluid to the heat transfer fluid the first fluid input system is not adding the first heat transfer fluid to the heat transfer fluid.

9. The method of claim 7, wherein the step of adding the second heat transfer fluid to the heat transfer fluid when the conductivity of the heat transfer fluid rises to the first setpoint level occurs while the height of the heat transfer fluid in the sump is above a first fluid height setpoint, the first fluid input system adds the first heat transfer fluid to the sump when the height of the heat transfer fluid is below the first fluid height setpoint.

10. The method of claim 9, wherein the continued addition of the second heat transfer fluid to the heat transfer fluid raises the height of the heat transfer fluid in the sump.

11. The method of claim 10, wherein a fluid outlet system removes a portion of the heat transfer fluid from the sump during the continued addition of the second heat transfer fluid to the heat transfer fluid.

12. The method of claim 11, wherein the fluid outlet system is an overflow fluid conduit through which the heat transfer fluid flows due to gravity.

13. The method of claim 11, wherein the fluid outlet system is a valve which is opened to remove the heat transfer fluid.

14. The method of claim 1, wherein the second fluid input system is independent of the first fluid input system.

15. The method of claim 14, wherein the first fluid input system and the second fluid input system are independently coupled to a supply of fluid and at least one of the first fluid input system and the second fluid input system treats a respective fluid received from the supply of fluid to produce the respective first heat transfer fluid and the second heat transfer fluid.

16. The method of claim 14, further comprising the steps of:
coupling the second fluid input system to a supply of fluid; and
treating a fluid received from the supply of fluid to produce the second heat transfer fluid, the second conductivity of the second heat transfer fluid being lower than a conductivity of the fluid from the supply of fluid.

17. The method of claim 16, wherein the second fluid input system includes a membrane system which removes materials from the fluid received from the fluid supply to produce the second heat transfer fluid.

18. The method of claim 17, wherein the second fluid input system further includes an electrical treatment system which uses an alternating current to treat the fluid received from the fluid supply to produce the second heat transfer fluid.

19. The method of claim 18, wherein the electrical treatment device includes a wire wrapped around an exterior of a fluid conduit of the second fluid input system through which the alternating current is passed.

20. The method of claim 18, wherein the electrical treatment device includes at least two electrodes in direct contact with the fluid of the second fluid input system.

21. The method of claim 17, further comprising the steps of:
directing at least a portion of the second heat transfer fluid from the membrane system to a holding tank; and
cleaning the membrane system with the portion of the second heat transfer fluid in the holding tank.

22. The method of claim 17, further comprising the steps of:
directing the second heat transfer fluid from the membrane system to a holding tank; and
directing the second heat transfer fluid from the holding tank to the second injection point of the evaporative heat transfer system.

23. The method of claim 1, the heat transfer fluid is a water based liquid.

24. A method of regulating a heat transfer fluid of an evaporative heat transfer system having a sump which contains the heat transfer fluid; the method comprising the steps of:
providing a first fluid input system, the first fluid input system being in fluid communication with a first injection point of the evaporative heat transfer system, the first fluid input system providing a first heat transfer fluid to the evaporative heat transfer system, the first heat transfer fluid having a first conductivity;
providing a second fluid input system, the second fluid input system being independent of the first fluid input system and not in fluid communication with the first fluid input system, the second fluid input system being in fluid communication with a second injection point of the evaporative heat transfer system, the second fluid input system providing a second heat transfer fluid to the evaporative heat transfer system, the second heat transfer fluid having a second conductivity, the second conductivity being lower than the first conductivity;
circulating the heat transfer fluid to a first heat transfer system which adds heat to the heat transfer fluid and onto a second heat transfer system which removes heat from the heat transfer fluid through an evaporation of a portion of the heat transfer fluid;
monitoring a characteristic of the heat transfer fluid;
adding the first heat transfer fluid to the heat transfer fluid if a first value of the characteristic of the heat transfer fluid is reached; and
adding the second heat transfer fluid to the heat transfer fluid when a second value of the characteristic of the heat transfer fluid is reached, the first value of the characteristic of the heat transfer fluid and the second value of the characteristic of the heat transfer fluid being selected such that the heat transfer fluid reaches the second value of the characteristic of the heat transfer fluid prior to the first value of the characteristic of the heat transfer fluid.

25. The method of claim 24, wherein the characteristic is a height of the heat transfer fluid in the sump of the evaporative heat transfer system, the first value corresponding to a first height and the second value corresponding to a second height, the first height being lower than the second height.

26. The method of claim 24, wherein the characteristic is a conductivity of the heat transfer fluid of the evaporative heat transfer system, the first value corresponding to a first conductivity value of the heat transfer fluid and the second value corresponding to a second conductivity value of the heat transfer fluid, the first conductivity value being higher than the second conductivity value.

27. The method of claim 24, wherein the first injection point is the sump of the evaporative heat transfer system and the second injection point is one of the sump of the evaporative heat transfer system and a fluid conduit of the evaporative heat transfer system in fluid communication with the sump.

28. The method of claim 24, wherein the evaporation of the portion of the heat transfer fluid results in the conductivity of the heat transfer fluid rising.

29. The method of claim 24, wherein the continued addition of the second heat transfer fluid to the heat transfer fluid raises a height of the heat transfer fluid in the sump.

30. The method of claim 29, wherein a fluid outlet system removes a portion of the heat transfer fluid from the sump during the continued addition of the second heat transfer fluid to the heat transfer fluid.

31. The method of claim 30, wherein the fluid outlet system is an overflow fluid conduit through which the heat transfer fluid flows due to gravity.

32. The method of claim 30, wherein the fluid outlet system is a valve which is opened to remove the heat transfer fluid.

33. The method of claim 30, wherein the second fluid input system includes a membrane system which removes materials from the fluid received from the fluid supply to produce the second heat transfer fluid.

34. The method of claim 33, wherein the second fluid input system further includes an electrical treatment system which uses an alternating current to treat the fluid received from the fluid supply to produce the second heat transfer fluid.

35. The method of claim 34, wherein the electrical treatment device includes a wire wrapped around an exterior of a fluid conduit of the second fluid input system through which the alternating current is passed.

36. The method of claim 34, wherein the electrical treatment device includes at least two electrodes in direct contact with the fluid of the second fluid input system.

37. The method of claim 33, further comprising the steps of:
directing at least a portion of the second heat transfer fluid from the membrane system to a holding tank; and
cleaning the membrane system with the portion of the second heat transfer fluid in the holding tank.

38. The method of claim 33, further comprising the steps of:
directing the second heat transfer fluid from the membrane system to a holding tank; and
directing the second heat transfer fluid from the holding tank to the second injection point of the evaporative heat transfer system.

39. The method of claim 24, the heat transfer fluid is a water based liquid.

40. An apparatus for regulating a heat transfer fluid of an evaporative heat transfer system having a sump containing the heat transfer fluid and a fluid circuit which circulates the heat transfer fluid to a first heat transfer system which adds heat to the heat transfer fluid, the evaporative heat transfer system removing heat from the heat transfer fluid through an evaporation of a portion of the heat transfer fluid, the evaporative heat transfer system including a first valve which adds a first heat transfer fluid to the heat transfer fluid when a fluid level of the heat transfer fluid in the sump falls below a first height setpoint; the apparatus comprising:
a fluid treatment device which receives fluid from a fluid supply, the fluid being independent of the evaporative heat transfer fluid, the fluid treatment device treating the received fluid to produce a second heat transfer fluid having a second conductivity lower than a first conductivity of the first heat transfer fluid;
a second valve having a first configuration wherein the second heat transfer fluid is not added to the heat transfer fluid and a second configuration wherein the second heat transfer fluid is added to the heat transfer fluid of the heat transfer system;
a sensor which monitors a conductivity of the heat transfer fluid; and
a controller which is operatively coupled to the second valve, the controller configuring the second valve in the second configuration when the conductivity of the heat transfer fluid rises to a first setpoint level, the second conductivity of the second heat transfer fluid being lower than the first setpoint level, and configuring the second valve in the first configuration when the conductivity of the heat transfer fluid falls to a second setpoint level, the second conductivity of the second heat transfer fluid being lower than the second setpoint level.

41. The apparatus of claim 40, wherein the first setpoint is selected to correspond with the fluid height of the heat transfer fluid being above the first height setpoint.

42. The apparatus of claim 41, wherein the addition of the second heat transfer fluid raises the fluid height of the heat transfer fluid in the sump.

43. The apparatus of claim 40, wherein the fluid treatment device includes a membrane system which removes materials from the fluid received from the fluid supply to produce the second heat transfer fluid.

44. The apparatus of claim 43, wherein the fluid treatment device further includes an electrical treatment system which uses an alternating current to treat the fluid received from the fluid supply to produce the second heat transfer fluid.

45. The apparatus of claim 44, wherein the electrical treatment device includes a wire wrapped around an exterior of a fluid conduit through which the alternating current is passed.

46. The apparatus of claim 44, further comprising a holding tank which receives the second heat transfer fluid from the membrane system, wherein fluid from the holding tank is then passed through the second value to the sump of the evaporative heat transfer system.

47. The apparatus of claim 44, further comprising a holding tank which receives a portion of the second heat transfer fluid from the membrane system, the portion of the second heat transfer fluid being used to clean the membrane system.
